(19) United States
(12) Patent Application Publication
(10) Pub. No.: US 2004/0194505 A1
(43) Pub. Date: Oct. 7, 2004

(54) Method of making a photonic crystal preform

(76) Inventors: Ji Wang, Painted Post, NY (US); John F. Wight JR., Corning, NY (US)

Correspondence Address: CORNING INCORPORATED, SP-TI-3-1, CORNING, NY, 14831

(21) Appl. No.: 10/405,679

(22) Filed: Apr. 1, 2003

(51) Int. Cl. B32B 1/00

(52) U.S. Cl. 65/17.5; 65/22; 65/144; 428/542.8

(57) ABSTRACT

Disclosed is a method of making a photonic crystal preform using a pore former in combination with silica particles and a binder to form a paste that can be extruded into a greenware body. The pore former can be removed from the greenware body by heating. The brownware body resulting from the heating step has a high porosity that facilitates the removal of impurities, including OH, during subsequent cleansing and sintering stages. The methods disclosed allow the manufacture of relatively large photonic crystals and are flexible enough to provide a periodic array of channels or passageways as the crystal features.

### BACKGROUND AND SUMMARY

1. Field of the Invention

This invention relates to vitreous honeycomb structures produced by extrusion from silica soot paste. More specifically, the invention relates to a method of manufacturing an extruded photonic crystal preform.

2. Background of the Invention

A photonic crystal is a structure having a periodic variation in dielectric constant. The periodic structure may be 1, 2 or 3 dimensional. The photonic crystal allows passage of certain light wavelengths and prevents passage of certain other light wavelengths. Thus, the photonic crystals are said to have allowed light wavelength bands and band gaps that define the wavelength bands that are excluded from the crystal.

At present, the wavelengths of interest for telecommunication applications are in the range of about 800 nm to 1625 nm. Of particular interest is the wavelength band in the range of about 1300 nm to 1600 nm.

Light having a wavelength in the band gap may not pass through the photonic crystal. However, light having a wavelength in bands above and below the band gap may propagate through the crystal. A photonic crystal exhibits a set of band gaps which are analogous to the solutions of the Bragg scattering equation. The band gaps are determined by the pattern and period of the variation in dielectric constant. Thus the periodic array of variation in dielectric constant acts as a Bragg scatterer of light of certain wavelengths in analogy with the Bragg scattering of x-rays wavelengths by atoms in a lattice.

Introducing defects into the periodic variation of the photonic crystal dielectric constant can alter allowed or non-allowed light wavelengths that can propagate in the crystal. Light which cannot propagate in the photonic crystal but can propagate in the defect region will be trapped in the defect region. Thus, a line defect within the crystal can serve as a localized “light tunnel”. Specifically, a line defect in the photonic crystal can act as a waveguide for a mode having a wavelength in the band gap, the crystal lattice serving to confine the guided light to the defect line in the crystal. A particular line defect in a three dimensional photonic crystal would act as a waveguide channel for light wavelengths in the band gap. A review of the structure and function of photonic crystals is found in, “Photonic Crystals: putting a new twist on light”, Nature, vol. 386, Mar. 13, 1997, pp. 143-149, Joannopoulos et al.

A first order band gap phenomenon is observed when the period of the variation in dielectric constant is of the order of the light wavelength which is to undergo Bragg scattering. Thus, for the wavelengths of interest, i.e., in the range of about 1300 nm to 1600 nm, as set forth above, a first order band gap is achieved when the period of the variation is about 500 nm. However, photonic crystal effects can occur in crystals having dielectric periodicity in the range of about 0.1 μm to 5 μm. Nevertheless, a two or three-dimensional photonic crystal having even a 5 μm spatial periodicity is difficult to fabricate.

Conventional processes have been used to create glass honeycomb structures suitable for forming photonic crystals. The prior art approaches to manufacturing this type of glass honeycomb article are either to fuse individual rods and/or hollow tubes together or to machine out a solid piece of glass to form a multi-channeled article.

These prior art processes are problematic for several reasons. Firstly, it is difficult to fuse multiple rods and/or hollow capillary tubes to form a multi-channeled article which can then optionally be hot-drawn down and re-bundled again and again into a progressively finer and finer array of hollow channels. Secondly, it is difficult to assemble and fuse multiple rods and/or hollow tubes uniformly into a perfect honeycomb structure. Thirdly, the diameter of the individual rods and/or hollow tubes that can be easily handled limits the number of tubes in the first bundle towards making the honeycomb structure, because there is a practical limit to the diameter of the assembly that can be uniformly hot-drawn down. Lastly, it is extremely expensive and time consuming to machine a multitude of deep channels into a glass object.

Ceramic honeycomb structures such as Celcor® (a cordierite honeycomb structure used commercially as a substrate for automotive catalytic converters. Celcor® is a registered trademark of Corning Incorporated) and glass-ceramic mixtures have been paste-extruded from particulate material, but the resulting honeycomb article is not transparent to light, significantly reducing its utility. In addition, the honeycomb article is crystalline in nature, making post-forming operations difficult. Further, the particle sizes of the raw material used in the Celcor® process are relatively large. The particle size can significantly affect the minimum wall thickness for an extruded honeycomb structure.

U.S. Pat. No. 6,260,388 to Borrelli discloses a method of making multi-channeled structures by extruding a silica-containing paste. In this method, a paste comprised of glass soot powders and a binding agent is extruded and sintered to form an optical fiber preform.

A disadvantage of the foregoing extrusion method is the low porosity and poor permeability of the greenware body as a consequence of high-pressure extrusion. Although light propagating in a photonic crystal structure comprising a plurality of channels or passageways propagates principally in a central channel or channels, a small percentage of the light also propagates in the walls of the channels. Contaminants contained in the channel walls therefore contribute to loss, or attenuation, of the propagating light.

The resulting low porosity of the greenware body resulting from high pressure extrusion may prevent the cleansing gas from adequately penetrating the body during subsequent processing, thereby reducing the efficiency with which the cleansing gas can remove contaminants.

Accordingly, there is a need for a method of making photonic crystal preforms that have high porosity and high permeability prior to sintering.

### SUMMARY OF THE INVENTION

In one embodiment of the present invention, a method of making a photonic crystal preform is disclosed, wherein the method includes providing a paste comprising a pore former, extruding the paste to form a greenware body, and heat treating said greenware body to remove said pore former and form a brownware body. Preferably the pore former is sulfur.

Preferably the brownware body is chemically cleansed with a cleansing gas. Preferably the brownware body is cleansed with chlorine.

It is preferable that the paste also comprises a binder. Preferably, the binder may be a cellulose ether or a polymer.

In another embodiment an article for manufacturing a photonic crystal optical fiber preform is disclosed. The article comprises silica, and has a first face spaced apart from a second face, each face having an area. A plurality of channels extend from the first face to the second face, the channels forming openings in the respective faces. The channels are separated by intervening walls which have a cross section to separate the array of openings in the respective faces.

It is preferable that the article be unsintered. It is also preferable that the article has been de-binded. The article preferably has an open porosity of at least 60%, more preferably 70% and most preferably 80%.

Preferably, a cross section of the article perpendicular to its longitudinal axis is circular at the outermost diameter of the cross section. It is also preferable that the article comprises at least 100 channels, more preferably at least 200 channels, and most preferably at least 400 channels.

Additional features and advantages of the invention will be set forth in the detailed description which follows, and in part will be readily apparent to those skilled in the art from the description or recognized by practicing the invention as described in the written description and claims hereof, as well as in the appended drawings.

It is to be understood that both the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification. The drawings are not necessarily to scale. The drawings illustrate one or more embodiment(s) of the invention, and together with the description serve to explain the principles and operation of the invention.

### BRIEF DESCRIPTION OF THE DRAWINGS

A complete understanding of the present invention may be obtained by reference to the accompanying drawings, when considered in conjunction with the subsequent detailed description, in which:

FIG. 1 shows an end cross-sectional view of a simplified glass honeycomb article in accordance with the present invention.

FIG. 2 schematically illustrates a side cross-sectional view of a simplified glass honeycomb article in accordance with the present invention.

FIG. 3 illustrates the pore types that may comprise a channel wall in accordance with the present invention.

FIG. 4 illustrates the cumulative pore volume of a chemical vapor deposition soot body compared to an extruded body without the use of a pore former.

FIG. 5 depicts schematically a method of making a photonic crystal preform in which the present invention is embodied.

FIG. 6 depicts the results of thermogravimetric analysis performed on the extruded greenware body to determine a suitable burnout temperature.

FIGS. 7 and 8 illustrate manifolding a honeycomb extruded body, comprising a large number of individual channels, to improve cleansing with a cleansing gas.

For purposes of clarity and brevity, like elements and components will bear the same designations and numbering throughout the figures.

### DETAILED DESCRIPTION OF THE INVENTION

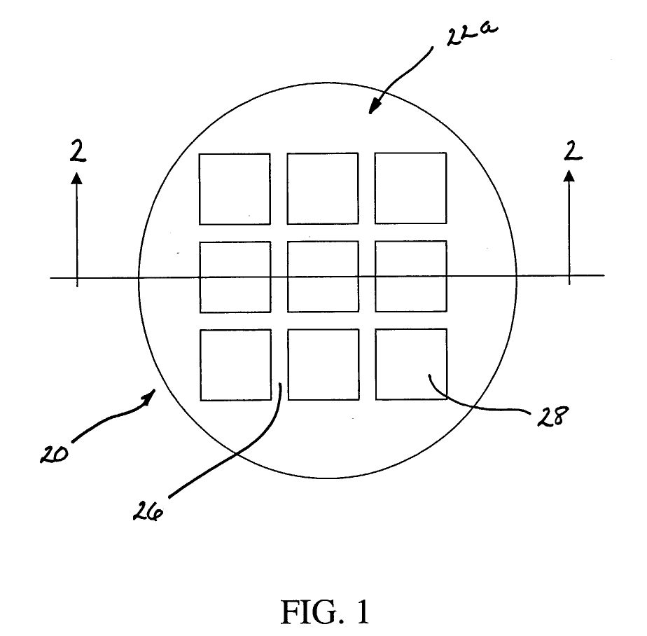

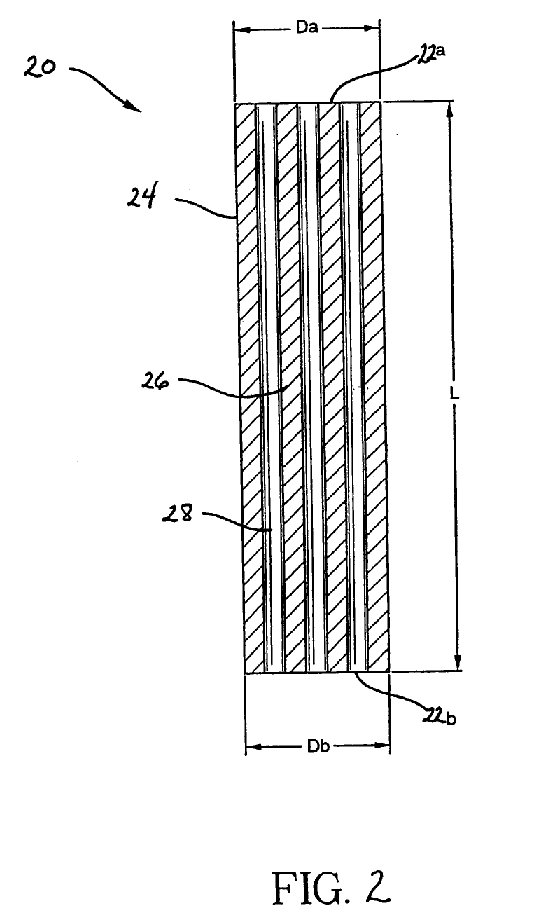

By way of definition, and referring to FIGS. 1 and 2, the term “honeycomb structure” or honeycomb greenware body, or honeycomb brownware body, or similar reference, as used in the specification, describes an extruded article 20 having two opposing generally planar faces 22a and 22b (not shown in FIG. 1), outer longitudinal surface 24 of length L and which surface is preferably a cylinder, and a matrix of cell walls 26 defining an array of channels, cells or through-holes 28, wherein each opposing face has a corresponding cross-sectional surface area and average cross-sectional diameter (Da and Db respectively), and each channel traverses, along a longitudinal axis, from the first face 22a to the second face 22b. The opposing faces may have identical cross-sectional surface areas in which case the channels will traverse the honeycomb article parallel to each other. The channels may be disposed randomly or at a fixed distance from each other. This distance is defined by the cell wall thickness. The channels also will have a cross-sectional shape and size defined by the cell wall. All closed shapes (e.g. circles, ellipses, triangles, squares, rectangles, hexagons) are allowed. The individual channels can be of all the same shape or mixtures thereof. The cross-sectional size of the channels can be either fixed for all channels or vary within the honeycomb article. Note that FIGS. 1 and 2 are illustrations of a simplified honeycomb structure comprising only a few channels. Honeycomb structures according to the present invention preferably comprise at least 100 channels, more preferably at least 200 channels, and most preferably at least 400 channels.

A conventional method for producing a glass article for use in the fabrication of an optical fiber includes synthesizing glass soot by flame hydrolysis, wherein glass forming chemical precursors, such as, for example, SiCl₄ and GeCl₄, are introduced into a burner flame and hydrolyzed and/or oxidized. The resulting glass soot may be deposited longitudinally on the periphery of a rotating starting rod to form a porous glass preform. The porous glass preform is then heated in an atmosphere containing a cleansing gas, such as, for example, chlorine, that removes, inter alia, hydrogen-containing species such as OH radicals and transition metals. The cleansed preform is then further heated to a temperature sufficient to sinter the glass soot, thereby forming a consolidated, or sintered glass preform. By sintered we mean the glass is made clear and nonporous, being either substantially or completely free of interstitial voids that characterize the space between individual glass particles comprising soot in a porous glass preform.

The foregoing process is generally referred to as outside vapor deposition (OVD), one of a number of processes that comprises the family of chemical vapor deposition processes. Glass soot may also be deposited axially in a process commonly referred to as vapor axial deposition (VAD). As in the OVD process, VAD requires that the porous glass preform be cleansed and sintered after the soot deposition step to form a nonporous glass preform. Examples of vapor deposition processes for forming optical waveguides are provided in U.S. Pat. Nos. 3,711,262; 3,737,292 and 3,737,293.

It is known in the outside vapor deposition method of manufacturing optical fiber performs that once the porosity of the preform becomes less than about 70% porosity during the cleansing/sintering phase of the process, the soot preform becomes difficult to cleanse because the cleansing gas is unable to reach to all the interstitial areas between the silica soot particles.

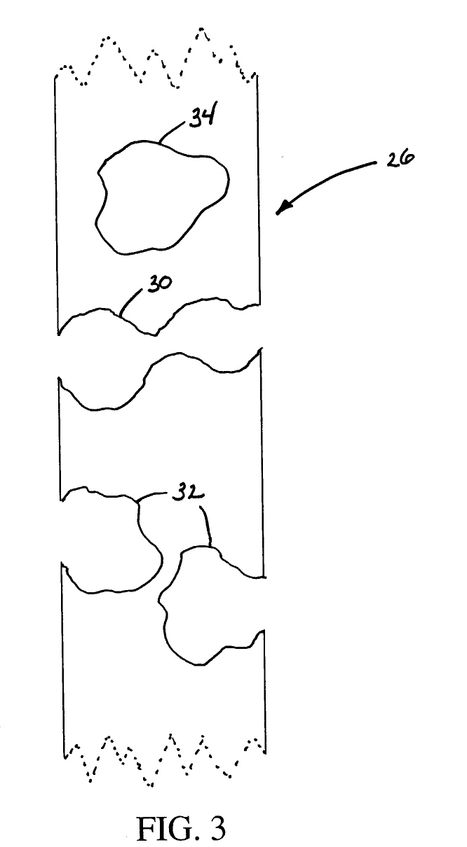

The skilled artisan will recognize from the discussion, supra, that a porosity of the extruded preform sufficient to ensure adequate cleansing is preferable. The pore structure of the extruded preform may be difficult to characterize because the pore shape can be very complex. Interconnected pores normally have irregular cross-sections that vary along the pore path. As shown in FIG. 3, through pores 30 extend from one side of a channel wall 26 to the other and permit fluid and/or gas flow. Blind pores 32 terminate inside the channel wall 26. Blind pores do not permit fluid and/or gas flow, but blind pores provide additional surface area for reaction by the cleansing gas. Closed pores 34 are not accessible and therefore are not beneficial for cleansing the preform. Hereinafter the term open pore or pores will refer cumulatively to blind pores and through pores, and the term open porosity will refer to the porosity of a body in terms of its open pores. By open porosity we mean the total pore volume of open pores (open pore volume) divided by the sum of the total volume of the body and the open pore volume. The open porosity expressed as a percent, P_{O}, is equal to:

P_{O}=Vₚ/(V_{b}+Vₚ)×100%

where Vₚ=the total volume of open pores; and

V_{b} is the total volume of the body.

It is to be understood that the open porosity of the body does not include the extruded channels. That is, the total volume of the body V_{b} is the total solid volume of the body, and closed pores are assumed not to exist.

Pore characterization may be performed using a variety of measurement methods. Such methods include extrusion flow porometry, extrusion porosimetry, mercury intrusion porosimetry, non-mercury intrusion porosimetry, vapor adsorption, and vapor condensation. Such techniques, either singly or in conjunction with each other, are capable of measuring, for example, the largest pore diameter, mean pore diameter, pore shape, pore distribution, pore volume and other pore attributes. These measurement methods are well known in the art and will not be discussed further. However, see, for example, “Characterization of Pore Structure of Filtration Media”, Fluid/Particle Separation Journal, vol. 14, December 2002, Jena et al.

In accordance with the invention, the extruded body preferably has an open porosity similar to the porosity for a pre-sintered vapor deposited preform to facilitate the removal of contaminants during chemical cleansing. The open porosity of the extruded body during chemical cleansing, according to the present invention, should preferably be greater than about 60%, more preferably greater than about 70% and most preferably greater than about 80%.

In the present invention, silica glass particles are blended with other materials to form an extrudable paste. By paste we mean a soft plastic mixture or composition. The paste may then be extruded into the desired shape.

The glass particles may be obtained by grinding fused silica glass. However, particles obtained by grinding typically may include metallic and oxide wear products originating from the grinding surfaces and thus particles formed in this manner are less preferred.

Commercially available silica glass particles may also be employed. Such glass particles may be in the form of aqueous colloidal suspensions of silica particles, such as Ludox®, a product of GRACE Davison, or “fumed” silica such as Cab-o-Sil®, a product of Cabot Corporation. The mean diameter of silica particles comprising these products can range from about 0.04 μm in effective diameter to about 5 μm in effective diameter. Preferably, the glass particles are high purity fused silica soot.

Particle diameters and diameter distributions may be readily determined using commercially available equipment. For example, a Beckman Coulter Multisizer™ 3 Coulter Counter® may be employed. In this device, particles are suspended in a weak electrolytic solution and drawn through a small aperture separating two electrodes. An electric current flows between the electrodes. The voltage that is applied between the two electrodes creates a sensing zone. Particles passing through the sensing zone displace their own volume of electrolytic fluid, thereby increasing the impedance of the aperture. The change in impedance produces a proportional change in current flow between the electrodes. The change in current is converted to a voltage pulse, and the amplitude of the pulse is proportional to the volume of the particle that produced it. Software in the equipment calculates an effective particle diameter based on the particle volume. That is, the effective diameter of a particle is the diameter of a spherical particle having a volume equivalent to the volume of the measured particle. As used hereinafter, the term “diameter”, when used in relation to particle diameter, shall mean the effective diameter of the particle or particles. Scaling of the pulse amplitudes enables a particle diameter distribution to be acquired and/or displayed as well.

High purity fused silica soot is generated by a unique flame hydrolysis or flame combustion process under specifically designed environmental conditions. Similar to the OVD process described supra, high purity silicon containing chemical is introduced into an oxygen-hydrocarbon, or oxygen-hydrogen flame, to generate silica intermediates in an insulated enclosure which is maintained at temperatures above 1600° C. The silica intermediates include “seeds” of solid silicon dioxide several nanometers in size, gaseous silicon monoxide, and other intermediate silicon containing compounds from the flame hydrolysis or flame combustion reactions. The insulating enclosure is designed in such a way that the silica intermediates experience prolonged residence time under high temperature (>1600° C.) within the enclosure, during which time the solid silicon dioxide “seeds” grow and sinter simultaneously to generate larger high purity, dense, spherical soot particles before exiting the enclosure. Soot manufactured in this manner typically comprises less than about 0.002 ppm sodium, 0.010 ppm iron, 0.0001 ppm aluminum, 0.007 ppm zirconium, and less than about 900 ppm hydroxyl (OH). However, the soot may be intentionally doped with a dopant suitable for modifying the index of refraction or the viscosity of the silica glass. Suitable dopants include fluorine, boron, and germanium. The soot particles generally have a maximum diameter of less than about 0.5 μm and a mean diameter between about 0.3 μm and 0.4 μm.

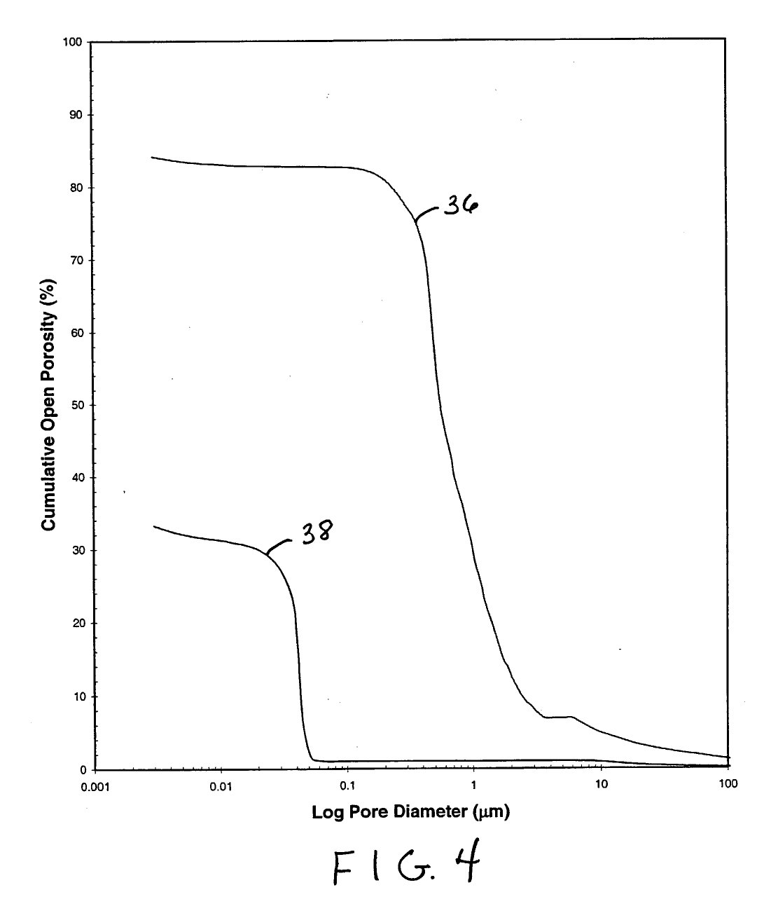

In the manufacture of an extruded preform body, the high extrusion pressure undesirably results in low open porosity and low permeability of the extruded body. This is illustrated by FIG. 4 where curve 36 represents the cumulative open porosity of a soot body manufactured by a chemical vapor deposition process as a function of pore diameter, compared with the cumulative open porosity of a conventionally extruded soot body, curve 38. Looking at curve 36, FIG. 4 first suggests that there is an upper limit to pore diameter of about 10 μm. This is borne out by experimentation that has shown that incomplete pore collapse occurs when the pore diameter exceeds about 10 μm. However, in the case where pore diameter does exceed about 10 μm in diameter, a process called hot isostatic pressing (HIPing) may be employed to ensure complete collapse of the pores. HIPing is performed during sintering by pressurizing the sintering furnace with a gas comprising argon. Argon is not readily soluble in silica glass. The gas pressure provides the additional force necessary to precipitate collapse of the pores.

FIG. 4 also demonstrates that the open porosity of the extruded greenware body is significantly less than the open porosity of vapor deposited soot. As with a silica preform manufactured by a soot-depositing chemical vapor process, the low open porosity of a conventionally extruded silica preform makes the structure difficult to cleanse. For this reason a high permeability is also preferable. That is, a large number of through pores increases the reach of the cleansing gas. The flow of fluids through porous media is proportional to the pressure gradient causing the flow, taking into account the viscosity of the fluid. Thus, permeability can be determined by measuring the fluid flow rate and differential pressure across the body to be measured. The fluid may be a gas. Gas permeability may be measured by employing flow porometry. See “Characterization of Pore Structure of Filtration Media”, Fluid/Particle Separation, vol. 14, December 1002, Jena et al.

In the present invention, when a pore-forming agent (pore former) is added to the silica paste from which an extruded silica body is formed, the open porosity and the permeability of the extruded silica body can be greatly improved once the pore former is removed. The pore former serves to occupy space within the extruded greenware body. By greenware body we mean an extruded body comprising silica glass, a pore former and a binder. When the pore former is removed, a pore is left in its place. Preferably the mean particle diameter of the pore former is less than about 30 μm, more preferably less than about 10 μm and most preferably less than about 4 μm. To maximize the open porosity of the extruded body, it is beneficial to remove the pore former at a temperature such that sintering of the silica particles does not occur. During sintering individual glass particles flow together, thereby reducing the exposed surface area of the glass particles and exposing less of the glass to the cleansing gas. In addition, as temperatures approach the sintering temperature of the glass, contaminants on the surface of the glass particles can be driven into the particles. In a further mechanism, contaminants located at the contact point between individual particles can be completely engulfed by the glass particles as they flow together during sintering. Therefore, it is desirable that the pore former is capable of being removed from the greenware body at relatively low temperatures, i.e. below the sintering temperature. It is also desirable that the pore former be non-reactive with the silica particles. Preferably the pore former should not leave behind contaminants. Prior art processes for manufacturing ceramic articles, such as Celcor™ filters, typically may utilize carbon black, talc or starch particles as pore formers. However, these materials tend to leave behind ash or other contaminants and are, therefore, undesirable in the manufacture of photonic crystal preforms. Carbon black especially is thought to form SiC, which is difficult to remove.

In the present invention, sulfur may be advantageously used as a pore former in the manufacture of photonic crystal preforms. Sulfur is elemental and easily obtained. Sulfur also has a relatively low boiling point, is sublimable and does not react with silica over the temperature ranges contemplated by the present invention.

Sulfur suitable as a pore former may be obtained either as a dry powder or as an aqueous dispersion. One particular drawback to the use of sulfur in an industrial environment is its explosive nature when used in a finely powdered form. As a consequence, powdered sulfur having a mean particle diameter below about 30 μm is difficult to obtain. On the other hand, aqueous sulfur dispersions having a mean particle diameter as low as 4 μm are readily obtainable. Preferably, the pore former is an aqueous sulfur dispersion.

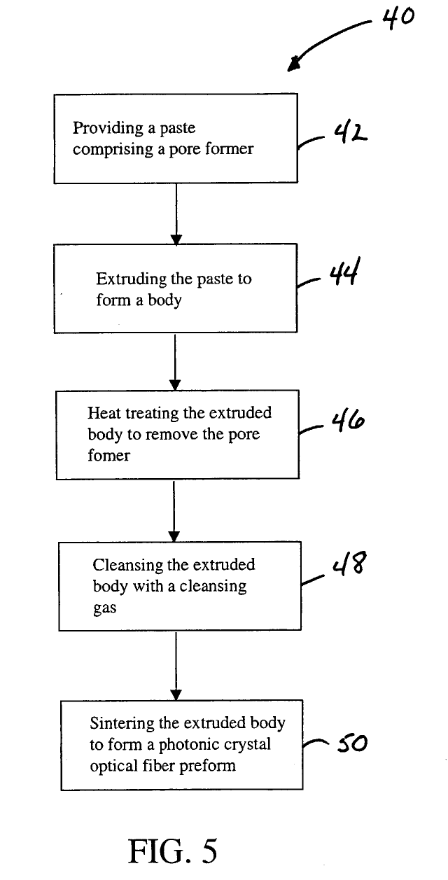

FIG. 5 depicts a method 40 of making a photonic crystal preform in which the present invention is embodied.

The method 40 includes the step 42 of providing a paste that may be extruded to form a honeycomb body. In step 42 silica glass particles are screened at a mesh of 100 to remove any large particles and agglomerates. Preferably the silica glass particles comprise a soot. The screened glass particles are then turbulized with a dry powdered binding agent (binder) and a dry powdered pore former. Preferably, the pore former is sulfur. When extruded, the binder serves to hold the glass particles together until bonds can form between the particles. Preferably, the binder has a mean particle diameter less than about 30 μm, more preferably less than 15 μm, and most preferably less than about 1 μm. Preferably, the binder is a cellulose ether or a polymer. An example of a suitable cellulose ether binder is Methocel™, manufactured by Dow Corning. A suitable polymer binder is Evanol™, a polyvinyl alcohol produced by DuPont. Evanol® has less sodium ash than Methocel®, and therefore is more desirable. However, chemical cleaning of the extrudate before its final sintering will significantly reduce sodium to the degree that the extrudate is purer than the starting powder.

Once combined, the glass particles-binder-pore former mixture is mixed with de-ionized water and a lubricating emulsion to form an extrudable paste. Preferably the glass particles, binder, and pore former are mixed for at least about 10 minutes, more preferably at least about 20 minutes, and most preferably at least about 30 minutes. A suitable lubricant is sodium stearate. However, it is generally desirable to minimize the sodium content of the paste since sodium tends to cause devitrification that may lead to cracking and/or spalling of the sintered preform. Thus, another preferred lubricant is stearic acid, more preferably oleic acid. To ensure adequate particle coverage by the lubricant, oleic acid is emulsified into the water with the aid of triethanolamine (TEA).

The method 40 further includes the step 44 of extruding the bulk paste resulting from mixing into long thin strands of paste in a process referred to as spaghetti extrusion. Spaghetti extrusion subjects the paste to high shear forces to ensure that the paste is de-agglomerated and well mixed. Preferably, the paste is spaghetti extruded at least twice, more preferably at least three times. After being spaghetti extruded, the paste is then extruded through a Celcor™ die to obtain a honeycomb greenware body having a desired channel arrangement. See U.S. Pat. Nos. 3,790,654 (Bagley) and 4,902,216 (Cunningham) for a description of Celcor™ dies.

The method 40 further includes the step 46 of heat treating the wet, greenware body resulting from the step 44 to remove excess water in a drying step. Preferably, drying is performed between about 40° C. and 100° C. for at least 24 hours, more preferably between about 45° C. and 75° C., and most preferably between about 50° C. and 60° C. Preferably, drying is performed in an atmosphere comprising air, and more preferably in an atmosphere comprising an inert gas such as nitrogen or helium. Alternatively, drying may be performed in a vacuum.

The dry honeycomb greenware body extruded from the Celcor™ die is further heat treated to remove the pore former and decompose the binder, forming a brownware body. This stage is referred to as de-binding. Brownware is unsintered de-binded greenware. An example of a suitable de-binding schedule is shown below:

a. heat the greenware body from room temperature to about 50° C. at about 2.3° C./min.

b. hold the temperature at about 50° C. for 6 hours;

c. ramp the temperature from about 50° C. to 110° C. at 1° C./min;

d. hold the temperature at about 110° C. for 10 hours;

e. ramp the temperature from about 110° C. to 280° C. at 1° C./min;

f. hold the temperature at about 280° C. for 10 hours;

g. ramp the temperature from about 280° C. to 450° C. at 0.5° C./min;

h. hold the temperature at about 450° C. for 40 hours;

i. allow the brownware body resulting from steps a. through h. to cool to room temperature at about 1.2° C./min.

Preferably, the greenware body is de-binded at a maximum temperature of between about 400° C. to 500° C., more preferably between about 425° C. and 475° C., and most preferably between about 440° C. and 460° C. Preferably, de-binding is performed for a period of at least 48 hours, more preferably at least 62 hours, and most preferably at least about 72 hours. It is desirable that de-binding be performed in an inert atmosphere such as nitrogen or helium. Alternatively, de-binding may be performed in a vacuum. De-binding may be performed in a suitable furnace or oven. For example, a sintering furnace used for the sintering of conventional chemical vapor deposited optical fiber preforms may be used.

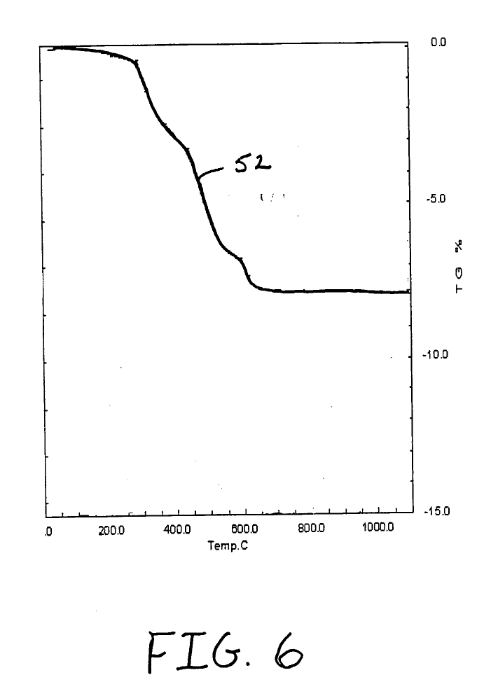

After de-binding, the brownware body may be further heated to a temperature suitable to burn out any remaining carbon residue, and in particular carbon ash. Curve 52 in FIG. 6 depicts the results of thermogravimetric analysis (TGA) performed on a sample of paste having been extruded in accordance with the present invention. TGA measures the weight change in a material as a function of temperature or time under a controlled atmosphere. Curve 52 suggests that a temperature greater than about 650° C. is sufficient to burn off any organic contaminants, such as, for example, carbon ash remaining from the breakdown of the binder. The relatively low temperature avoids the onset of sintering that would reduce the open porosity of the extruded body. Also, as discussed supra, a low temperature also minimizes the diffusion and entombment of contaminants on the surface of the glass particles. Preferably, burnout is performed at a temperature between about 650° C. to 950° C. for at least 12 hours, more preferably between about 650° C. and 800° C., and most preferably between about 650° C. and 750° C. Preferably burnout is performed in air.

Preferably the maximum pore diameter of the brownware body after removal of the pore former and the binder but prior to cleansing is between about 6 μm and 10 μm, more preferably between about 7 μm and 9 μm, and most preferably between about 7.5 and 8.5 μm. Preferably the permeability of the brownware body after removal of the pore former and the binder but prior to cleansing is greater than 0.001 Darcy, more preferably greater than about 0.005 Darcy, and most preferably greater than about 0.015 Darcy.

The method 40 further includes the step 48 of chemical cleansing. Chemical cleansing is performed after burnout but prior to the sintering step 50 to remove those contaminants not removed during the burnout step. Such contaminants include beta-OH and trace contaminants of alkali (e.g., sodium), alkaline earth elements, and iron from die wear. In this step, the brownware body is heated to a temperature between about 850° C. and 1300° C. for a period greater than about 20 minutes in an atmosphere comprising a suitable cleansing gas. Preferably the cleansing gas is chlorine. Preferably chemical cleansing is performed at a temperature of between about 800° C. and 1100° C., more preferably between about 850° C. and 1000° C., and most preferably between about 900° C. and 1000° C.

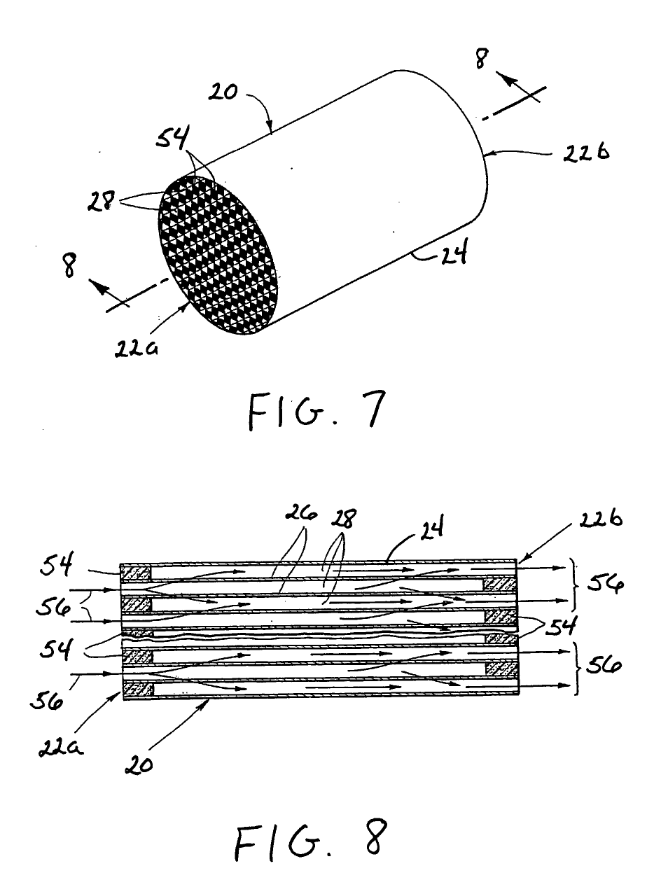

The efficiency of chemical cleansing can be further improved by manifolding the honeycomb brownware body and flowing the hot cleansing gas through the porous and permeable walls of the body. Referring to FIGS. 7 and 8, in this process a honeycomb brownware body 20, having a structure formed by a matrix of thin, intersecting, porous walls 26 which extend across and between two of its opposing end faces 22a and 22b (hidden) and which walls form a large plurality of hollow passages, or channels 28, extending from one end face to the other end face, has a first subset of channels sealed by plugs 54 at one endface and a second subset of channels sealed by plugs 54 at the opposing end face. The body is then said to have been manifolded. Either end face 22a or 22b of the manifolded brownware body 20 may be used as the inlet end face. The cleansing gas 56 is brought under pressure at an inlet end face 22a and enters the brownware body 20 through the channels that are open at the inlet end face (inlet channels). Because the inlet channels are sealed at the end located on the end opposing the inlet end face, hereafter referred to as the outlet end face, the cleansing gas is forced through the thin, porous walls 26 of the brownware body 20 into adjoining channels having open ends at the outlet end face and being sealed at the input end face, hereinafter referred to as the outlet channels. Hence, the cleansing gas flows in at the inlet end face 22a, through the inlet channels, further through the thin porous walls 26 separating adjoining outlet channels, through the outlet channels, and exiting from the outlet end face 22b. Other flow paths to facilitate cleansing are possible. For example, all channels openings at one end face, e.g. end face 22b, may be plugged. In this instance, cleansing gas flow resulting from a pressurized cleansing gas applied to the end face opposite the plugged end face, in this example end face 22a, would occur entirely through the porous and permeable walls of the brownware body and finally exiting the brownware body through surface 24. The channels may be plugged, for example, with the extrudable paste, after which the brownware body is heated to dry the paste. A detailed description of a means of manifolding can be found in U.S. Pat. No. 4,411,856.

The method 40 also includes the step 50 of sintering the brownware body resulting from the step 48. The brownware body is sintered to consolidate the body into a clear glass structure while retaining a plurality of channels extending from one end face to the other. A typical firing schedule to sinter the brownware body follows below:

a) load brownware body into furnace; draw a vacuum at room temperature;

b) heat furnace at about a 50° C./minute rate to about 1000° C.;

c) hold at 1000° C. for about 5-15 minutes;

d) increase temperature at about 10-15° C./minute to about 1650° C.;

e) increase temperature at about 2° C./minute to about 1760° C.;

f) hold at about 1760° C. for about 5-15 minutes;

g) backfill furnace with argon gas; and

h) cut off power to furnace and allow sintered body to cool at furnace rate to room temperature.

To ensure complete pore collapse occurs, HIPing may be performed during step (g)

The vacuum firing procedure given above is for the purpose of an illustrating example. The firing can also be carried out effectively under air or inert gas atmosphere such as, for example, nitrogen, helium, argon, carbon dioxide, and mixtures thereof. The gas atmosphere can be applied at less than, but preferably equal to or greater than ambient pressure. Different heating rates and isothermal holding times will be employed when gas atmospheres are employed. The determination of the appropriate conditions is readily determined without excessive experimentation.

In a preferred embodiment of method 40, the pore former used in the step 42 of providing a paste is in the form of an aqueous dispersion. The glass particles are screened at 100 mesh and turbulized with the dry binder. The glass particle sand binder are then mixed with the pore former dispersion to form a paste. Mixing may be performed at an elevated temperature to remove excess liquid water introduced by the aqueous dispersion. Mixing is preferably performed at a temperature of between about 40° C. and 100° C., more preferably between about 45° C. and 75° C., and most preferably between about 50° C. and 60°. Preferably, mixing is performed in an atmosphere comprising air, more preferably in an atmosphere comprising an inert gas such as nitrogen or helium. Alternatively, the removal of excess water may be performed in a vacuum. After mixing, the paste resulting from the step 42 is processed as before, including the step 44 of extruding, the step 46 of heat treating, the step 48 of cleansing and the step 50 of sintering.

The preceding embodiments use de-ionized water as the solvent to prepare the starting paste. However, also useful in the present invention are aqueous organic solvent mixtures. Suitable organic solvents are the lower alcohols, ketones, amides, and esters. If utilized with water, these solvents must be sufficiently soluble in water to provide a homogeneous mixture. The ratio of water to solvent can vary from 95:5 to 5:95. Most preferred solvents are ethanol, acetone, methyl ethyl ketone, N,N-dimethylformamide, and ethyl acetate (see U.S. Pat. No. 5,458,834, Faber et al.). Alternatively, the paste may also be nonaqueous.

### EXAMPLE 1

In one experiment, 235.3 grams of high purity fused silica soot obtained a chemical vapor process was dry screened at 100 mesh to remove large particles and agglomerates. The screened silica soot was then dry turbulized with 23.8 grams of Methocel and 761.1 grams of Baker™ sulfur powder. The mean particle diameter of both the sulfur powder and the Methocel was about 30 μm. The mean particle diameter of the silica soot was about 0.4 μm. After turbulizing, the soot-binder-pore former blend was mixed in a lubricating emulsion comprising 151.3 grams de-ionized water, 7.6 grams of oleic acid, and 1.1 grams of TEA to form a paste. The paste was spaghetti extruded three times, then finally extruded using a Loomis™ extruder to form a honeycomb greenware body. The solids loading of the greenware body was approximately 72.5% by volume. The volume percentage of silica in the greenware body was approximately 16.3%, with an open porosity for the brownware body of about 83%.

### EXAMPLE 2

In a second experiment, 235.3 grams of high purity fused silica soot obtained from a chemical vapor process was dry screened at 100 mesh to remove large particles and agglomerates. The screened silica soot was then dry turbulized with 23.6 grams of Methocel. The mean particle diameter of the Methocel was 30 μm. The mean particle diameter of the silica soot was 0.4 μm. After turbulizing, the dry soot-binder blend was mixed with 920 grams of a Bostek® aqueous sulfur dispersion comprising 749.6 grams sulfur and 170.4 grams of water to form a paste. The mean particle diameter of the sulfur was 3 μm. The paste was then de-watered by mixing at 50° C. in a flowing nitrogen atmosphere. The paste was spaghetti extruded three times, then finally extruded using a Loomis™ extruder to form a honeycomb greenware body. The solids loading of the greenware body was approximately 71.4% by volume. The volume percentage of silica in the greenware body was approximately 16.3%, with an open porosity for the brownware body of about 83%.

### EXAMPLE 3

In a third example, 235.3 grams of high purity fused silica soot obtained from a chemical vapor process was dry screened at 100 mesh to remove large particles and agglomerates. The screened silica soot was then dry turbulized with 43.2 grams of Methocel. The mean particle diameter of the Methocel was 30 μm. The mean particle diameter of the silica soot was 0.4 μm. After turbulizing, the dry soot-binder blend was mixed with 920 grams of a Bostek® aqueous sulfur dispersion comprising 749.6 grams sulfur and 170.4 grams of water to form a paste. The mean particle size of the sulfur was 3 μm. The paste was de-watered by milling at 50° C. in a flowing nitrogen atmosphere. The paste was spaghetti extruded three times, then finally extruded using a Loomis™ extruder to form a honeycomb greenware body. The solids loading of the greenware body was approximately 69.3% by volume. The volume percentage of silica in the greenware body was approximately 15.8%, with an open porosity for the brownware body of about 84%.

It will be apparent to those skilled in the art that various modifications and variations can be made to the present invention without departing from the spirit and scope of the invention. Thus, it is intended that the present invention covers the modifications and variations of this invention provided they come within the scope of the appended claims and their equivalents.

We claim:

1. A method of making a photonic crystal preform comprising:
providing a paste comprising silica glass particles and a pore former;
extruding said paste to form a greenware body;
heat treating said greenware body to remove said pore former and forming a brownware body.

2. The method of claim 1 further comprising cleansing said brownware body in the presence of a cleansing gas.

3. The method of claim 2 wherein said cleansing gas comprises chlorine.

4. The method of claim 2 wherein said cleansing step comprises manifolding said brownware body.

5. The method of claim 1 wherein said silica glass particles comprise a silica soot.

6. The method of claim 1 wherein said pore former in said providing step comprises sulfur.

7. The method of claim 1 wherein said brownware body resulting from said heat treating step has an open porosity greater than about 70%.

8. The method of claim 1 wherein said brownware body resulting from said heat treating step has an open porosity greater than about 80%.

9. The method of claim 1 wherein said brownware body resulting from said heat treating step has a mean pore diameter between about 6 μm and 10 μm.

10. The method of claim 1 wherein said paste in said providing step further comprises a cellulose ether binder.

11. The method of claim I wherein said paste in said providing step further comprises a polymer binder.

12. The method of claim 1 wherein said silica glass particles have a mean diameter less than about 5 μm.

13. The method of claim 1 wherein said silica glass particles have a mean diameter less than about 0.5 μm.

14. The method of claim 1 wherein said pore former in said forming step has a mean particle diameter less than about 30 μm.

15. The method of claim 1 wherein said pore former in said forming step has a mean particle diameter less than about 4 μm.

16. The method of claim 1 wherein a burnout of said brownware body is performed after said heat treating step, said burnout being performed at a temperature between about 650° C. and 950° C.

17. An article for manufacturing a photonic crystal optical fiber preform comprising:
a first face spaced apart from a second face, and each face having an area;
a plurality of channels extending from said first face to said second face and forming openings in the respective faces;
wherein said channels are separated one from another by intervening walls which have a cross section to separate the array of openings, one from another, in the respective faces; and
said article being comprised of silica glass and having an open porosity greater than about 60%.

18. The article of claim 17 wherein said open porosity is greater than about 80%.

19. The article of claim 17 wherein said article comprises at least 100 channels.

20. The article of claim 17 wherein said article comprises at least 400 channels.
